(19) United States
(12) Patent Application Publication
(10) Pub. No.: US 2007/0019149 A1
(43) Pub. Date: Jan. 25, 2007

(54) LIQUID-CRYSTAL DISPLAY PANEL

(75) Inventors: Yukihiro Kudo, Kumamoto (JP); Takeshi Ohashi, Kumamoto (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 11/420,397

(22) Filed: May 25, 2006

(30) Foreign Application Priority Data
Jul. 21, 2005 (JP) 2005-211121

(51) Int. Cl. G02F 1/1339

(52) U.S. Cl. 349/155

(57) ABSTRACT

The present invention provides an in-plane switching type liquid-crystal display panel using spacer beads that is capable of preventing defective alignment of liquid crystal around the spacer beads to prevent leakage of light and to constantly sustain superior display quality. According to the present invention, a liquid-crystal display panel includes an electrode substrate, an opposing substrate, liquid crystal sandwiched between the electrode substrate and the opposing substrate, a large number of raised portions formed in a distributed manner in positions that correspond to a light shield film on the opposing substrate, and a large number of spacer beads retained between the electrode substrate and the raised portions and forming a gap between the electrode substrate and the opposing substrate, wherein voltage is applied to the pixel electrodes to produce electric fields approximately in parallel with a plane defined by the electrode substrate so that the liquid crystal reacts in the in-plane direction of the first substrate on the basis of the electric fields, and wherein the spacer beads are surface-treated to have adhesiveness so that the spacer beads adhere at least to the first substrate or the raised portions.

### BACKGROUND OF THE INVENTION

1. Field of the Invention

The present invention relates to a liquid-crystal display panel, and particularly to an in-plane switching type liquid-crystal display panel.

2. Description of the Background Art

In-Plane Switching (IPS) type liquid-crystal display panels were developed to achieve improvements in viewing angle over conventional liquid-crystal display panels. In the in-plane switching type liquid-crystal display panels, voltage is applied to pixel electrodes to produce electric fields approximately in parallel with the substrate plane so that liquid crystals react in the substrate plane direction on the basis of the electric fields.

One of the factors that affect image quality of the in-plane switching type liquid-crystal display panels is the cell gap (the gap between the substrates). In order to keep the cell gap uniform in the plane, the liquid-crystal display panels use spacers. Two kinds of spacers are available, including spherical spacers called “bead spacers” and column-like spacers called “post spacers”, and the in-plane switching liquid-crystal display panels chiefly use the post spacers.

Adopting spacer beads in an in-plane switching liquid-crystal display panel causes defective alignment of liquid crystal around the spacer beads, which results in leakage of light in those areas. Post spacers are chiefly used in the in-plane switching liquid-crystal display panels because they are free from this problem. Also, with post spacers, it is possible to form a necessary number of spacer elements of a desired height in predetermined positions, which enables production of liquid-crystal display panels of higher qualities as compared with those produced with spacer beads. However, the use of post spacers requires an additional process to form the post spacer elements on one substrate, leading to increased manufacturing costs.

To solve this problem, Japanese Patent Application Laid-Open No. 11-142863 (1999: hereinafter referred to as Patent Document 1) discloses an in-plane switching liquid-crystal display panel that uses spacer beads while preventing light leakage around the spacer beads.

In the display panel of Patent Document 1, a light shield film and color layers of red, green, and blue are formed on one substrate and an alignment layer is formed as the uppermost layer. In Patent Document 1, the light shield film and the color layers are formed such that the cell gap in the pixel areas is larger than the diameter of the spacer beads and the cell gap under the light shield film is smaller than the diameter of the spacer beads. Accordingly, when the one substrate is bonded to the other substrate on which pixel electrodes and the like are formed, the spacer beads under the light shield film are retained with pressure. That is, the areas where the light shield film and color layers reside form raised portions on the one substrate, and the raised portions retain the spacer beads, but the spacer beads in the pixel areas are not retained. Accordingly, no defective alignment occurs in the liquid crystal around the unretained spacer beads, and leakage of light is thus prevented.

However, according to Patent Document 1, the spacer beads are retained just with pressure between the raised portions and the other substrate. Therefore, when the substrates warp because of application of external forces, the raised portions and the other substrate can no longer retain the spacer beads between them. That is, while some spacer beads remain retained between the raised portions and the other substrate, some spacer beads are unretained and move freely. Then, the in-plane cell gap cannot be kept even, but it varies. Thus, the technique disclosed in Patent Document 1 is unable to keep good display quality under some conditions, as when the substrates undergo external forces.

### SUMMARY OF THE INVENTION

An object of the present invention is to provide an in-plane switching type liquid-crystal display panel using spacer beads that is capable of preventing defective alignment of liquid crystal around the spacer beads to prevent leakage of light and to constantly sustain superior display quality.

According to the present invention, a liquid-crystal display panel includes a first substrate on which a given pattern of pixel electrodes and interconnections is formed, a second substrate which is placed opposite the first substrate and on which a given pattern of light shield film is formed, liquid crystal sandwiched between the first substrate and the second substrate, a plurality of raised portions formed in a distributed manner on the second substrate in positions that correspond to the light shield film, and a plurality of spacer beads retained between the first substrate and the raised portions of the second substrate and forming a gap between the first substrate and the second substrate. In the liquid-crystal display panel of the invention, voltage is applied to the pixel electrodes to produce electric fields approximately in parallel with a plane defined by the first substrate so that the liquid crystal reacts in the in-plane direction of the first substrate on the basis of the electric fields. The spacer beads are surface-treated to have adhesiveness so that the spacer beads adhere at least to the first substrate or the raised portions of the second substrate.

According to the liquid-crystal display panel of the present invention, the spacer beads are surface-treated to have adhesiveness so that they adhere at least to the first substrate or the raised portions of the second substrate. This prevents defective alignment of the liquid crystal around the spacer beads and thus prevents leakage of light and constantly sustains superior display quality.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view of a liquid-crystal display panel according to a preferred embodiment of the present invention;

FIG. 2 is a diagram showing a relation between density of sprayed spacer beads and a gap “d” in the liquid-crystal display panel of the preferred embodiment of the invention; and

FIG. 3 is a diagram used to describe the gap “d” in the liquid-crystal display panel of the preferred embodiment of the invention.

### DESCRIPTION OF THE PREFERRED EMBODIMENTS

(Preferred Embodiment)

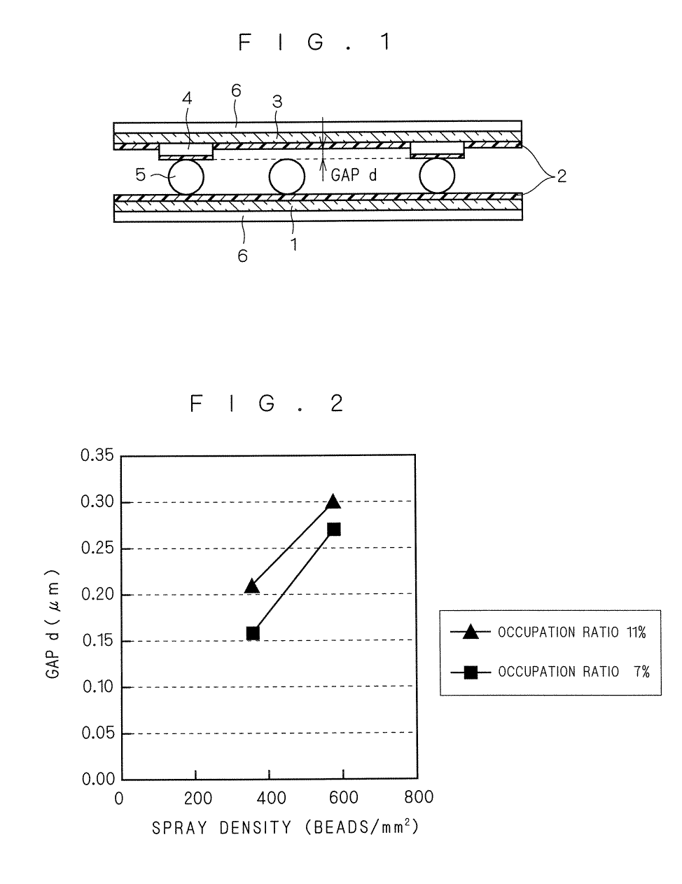

An in-plane switching type liquid-crystal display panel according to the present invention will now be described in detail referring to FIG. 1. FIG. 1 is a cross-sectional view of the liquid-crystal display panel of the invention.

While FIG. 1 does not show the detailed structure of an electrode substrate 1, a film of metal, for example, is formed on an insulative substrate, e.g., a glass substrate, and is patterned to form gate electrodes and common electrodes. Next, an interlayer insulating film is formed on the pattern of gate electrodes and common electrodes. Then, a semiconductor film is formed on the interlayer insulating film. After the formation of the semiconductor film, a metal film is deposited by, e.g., sputtering, to form source and drain electrodes. By these process steps, pixel electrodes, interconnections, thin film transistors (TFTs), and the like are formed on the electrode substrate 1. Next, an alignment layer 2 is formed as the uppermost layer on the electrode substrate 1. In an in-plane switching type display panel, the electrodes are shaped like, e.g., the teeth of a comb on the electrode substrate 1, and electric fields are produced approximately in parallel with the electrode substrate 1.

Also, while FIG. 1 does not show the detailed structure of an opposing substrate 3, a light shield film is formed on an insulative substrate, e.g., a glass substrate. The light shield film is formed in positions that face the interconnections and areas around the patterned pixel electrodes on the electrode substrate 1. After the formation of the light shield film, color layers are concurrently formed on the light shield film and in positions that face the pixel electrode pattern on the electrode substrate 1. The color layers include three colors: red, green and blue. Next, raised portions 4 are formed over the light shield film on which the color layers reside. The raised portions 4 may be formed of any of metal, resist, and resin, having a higher degree of hardness than the material of spacer beads 5 described later.

In the liquid-crystal display panel of this preferred embodiment, the area where the raised portions 4 are formed occupies 7% or more of the display area, and the raised portions 4 are formed in a distributed manner (e.g., uniformly) on the opposing substrate 3. The display area is the effective area where images are displayed in the liquid-crystal display panel.

On the opposing substrate 3, an overcoat film (not shown) is formed on the color layers, and an alignment layer 2 is formed further thereon. The alignment layer 2 is formed of a polyimide film. The alignment layers 2 formed on the electrode substrate 1 and the opposing substrate 3 are baked and then rubbed with rubbing cloth. The liquid crystals sandwiched between the electrode substrate 1 and the opposing substrate 3 are thus aligned in a given direction.

Then, a sealing material is applied to the peripheral area of the opposing substrate 3, and the spacer beads 5 are sprayed onto the electrode substrate 1. The sealing material can be of UV (ultraviolet) curing type or thermosetting type. The spacer beads 5 are those made by applying surface treatments, to give alignment control ability and thermal adhesiveness, to material beads of divinylbenzene. Specific examples of such products include surface-treated spacers (SP-type surface-treated spacers) produced by Sekisui Chemical Co. Ltd. and Natoco Spacers produced by Natoco Co. Ltd. Applying the alignment controlling treatment to the surfaces of the spacer beads 5 reduces disruption of alignment of liquid crystals around the spacer beads 5.

The thermal adhesiveness treatment applies a surface coating to the spacer beads 5 to give them a property of adhering to the substrates when heated. However, the thermal adhesiveness treatment adopted by the liquid-crystal display panel of this preferred embodiment is an illustrative example and not restrictive. Other types of treatments may be adopted to provide adhesiveness, as long as the treatments provide the spacer beads 5 with adhesion to the substrates and the like with which the spacer beads 5 are placed in contact.

Next, the electrode substrate 1 and the opposing substrate 3 are bonded together as shown in FIG. 1 to form a cell. Though not shown in FIG. 1, the electrode substrate 1 and the opposing substrate 3 are bonded with a sealing material. An injection port is formed in a part of the cell and the liquid crystal is injected into the cell through the injection port. The injection port is sealed with an end-sealing material, e.g., UV curing resin, after the liquid crystal has been put in. FIG. 1 does not show the injection port and end-sealing material.

Finally, polarizers 6 are bonded respectively to the electrode substrate 1 and the opposing substrate 3 to complete the liquid-crystal display panel of the preferred embodiment.

Next, the gap between the electrode substrate 1 and the opposing substrate 3 of the liquid-crystal display panel of the preferred embodiment, i.e., the cell gap, will be described. In this preferred embodiment, when the cell is fabricated as shown in FIG. 1, spacer beads 5 aligned with the raised portions 4 form the cell gap, and spacer beads 5 not aligned with the raised portions 4 form a gap “d” of 0.1 μm or more with the opposing substrate 3. That is, the diameter of spacer beads 5 not retained between the electrode substrate 1 and the raised portions 4 has a difference of 0.1 μm or more with respect to the gap between the electrode substrate 1 and the opposing substrate 3.

During the fabrication of the cell, the spacer beads 5 are heated so that they adhere to the raised portions 4 and the electrode substrate 1. The heating temperature is 120° C. or higher. Thus, in the liquid-crystal display panel of this preferred embodiment, the spacer beads 5 do not move even when the panel warps due to external forces. It is not essential to make the spacer beads 5 adhere to both of the electrode substrate 1 and the raised portions 4, but the spacer beads 5 may be made to adhere only to either of them, as long as the spacer beads 5 do not move even with application of external forces.

This preferred embodiment examined the gap d, with the raised portions 4 having a height of 0.2 μm and the spacer beads 5 having a diameter of 4.0 μm, and with the density of sprayed spacer beads 5 varied from 350/mm² to 600/mm².

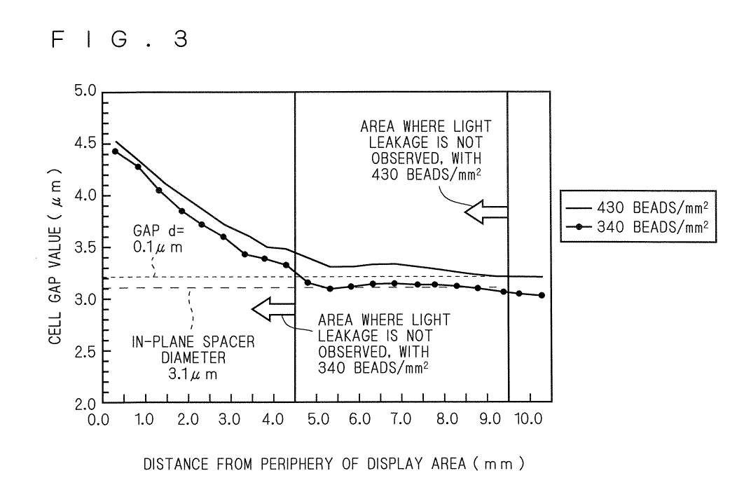

FIG. 2 shows a relation between the gap d and the density of sprayed spacer beads 5. In FIG. 2, the horizontal axis indicates the density of spray and the vertical axis indicates the gap d, and FIG. 2 shows data obtained when the area where the raised portions 4 are formed occupies 7% of the display screen (occupation ratio of 7%) and data obtained when the area where the raised portions 4 are formed occupies 11% of the display screen (occupation ratio of 11%). It is seen from FIG. 2 that occupation ratios of 7% or more ensure the gap d=0.1 μm or more, which is sufficient in consideration of manufacturing margin, even when the density of sprayed spacer beads 5 is 350/mm². When the raised portions 4 are formed in positions that correspond to the light shield film, the percentage of the area of the light shield film to the display screen corresponds to the upper limit of the occupation ratio of the raised portions 4.

In this preferred embodiment, no leakage of light was observed around the spacer beads even when the liquid-crystal display panel was impacted several tens of times by tapping. It is thought that leakage of light was prevented by leaving the gap d of 0.1 μm or more above unretained spacer beads 5 so that a sufficient liquid crystal layer forms between the spacer beads 5 and the opposing substrate 3.

Even when the liquid-crystal display panel warps due to external forces, the cell gap is kept even because the spacer beads 5 remain unmoving.

As described so far, the liquid-crystal display panel of this preferred embodiment is suitable as an in-plane switching liquid-crystal display panel. The liquid-crystal display panel uses the spacer beads 5 that are surface-treated to have alignment control ability and thermal adhesiveness, and a gap of 0.1 μm or more is ensured between unretained ones of the spacer beads 5 and the opposing substrate 3, which prevents leakage of light around the spacer beads and provides a higher-quality screen with a wider viewing angle. The idea of ensuring the gap d of 0.1 μm or more was obtained according to the experiments shown below.

In conventional liquid-crystal display panels, as to the cell gap in the peripheral portion of the display area and the cell gap in the central portion, the gap is made uniform in the entire display area by adjusting the in-sealing spacer. However, it is possible to form a difference between the cell gap in the peripheral portion of the display area and the cell gap in the central portion, by using in-sealing spacer having a diameter larger than the adjustment value. That is, it is possible to form a larger cell gap in the peripheral portion of the display area by using in-sealing spacer having a larger diameter, so as to form a gap (the gap d) between the in-plane spacer (spacer beads 5) and the pixel areas of the opposing substrate. By using this approach, we observed leakage of light from the periphery toward the center of the display area and examined the positions of light leakage and cell gap values in those positions. FIG. 3 shows the results of examination. FIG. 3 shows data obtained with two kinds of cells where the densities of spray were 340/mm² and 430/mm², with in-plane spacer (spacer beads 5) having a diameter of 3.1 μm. As can be seen from the results shown in FIG. 3, no leakage of light was observed from areas where the difference (the gap d) between the cell gap and the diameter of the in-plane spacer was 0.1 μm or more.

In the liquid-crystal display panel of this preferred embodiment, as shown in FIG. 1, the raised portions 4 are formed on the opposing substrate 3 in positions that correspond to the light shield film. However, this structure is shown by way of illustration and not of limitation. The raised portions 4 may be formed on the electrode substrate 1 in positions that correspond to interconnections formed thereon. This structure, too, prevents defective alignment of liquid crystals around spacer beads and prevents leakage of light, and constantly sustains superior display quality.

While the invention has been described in detail, the foregoing description is in all aspects illustrative and not restrictive. It is understood that numerous other modifications and variations can be devised without departing from the scope of the invention.

What is claimed is:

1. A liquid-crystal display panel, comprising:
a first substrate on which a given pattern of pixel electrodes and interconnections is formed;
a second substrate which is placed opposite said first substrate and on which a given pattern of light shield film is formed;
liquid crystal sandwiched between said first substrate and said second substrate;
a plurality of raised portions formed in a distributed manner on said second substrate in positions that correspond to said light shield film; and
a plurality of spacer beads retained between said first substrate and said raised portions of said second substrate and forming a gap between said first substrate and said second substrate, wherein voltage is applied to said pixel electrodes to produce electric fields approximately in parallel with a plane defined by said first substrate so that said liquid crystal reacts in an in-plane direction of the plane of said first substrate on the basis of said electric fields,
wherein said spacer beads are surface-treated to have adhesiveness so that said spacer beads adhere at least to said first substrate or to said raised portions of said second substrate.

2. The liquid-crystal display panel, comprising:
a first substrate on which a given pattern of pixel electrodes and interconnections is formed;
a second substrate which is placed opposite said first substrate and on which a given pattern of light shield film is formed;
liquid crystal sandwiched between said first substrate and said second substrate;
a plurality of raised portions formed in a distributed manner on said first substrate in positions that correspond to said interconnections; and
a plurality of spacer beads retained between said raised portions of said first substrate and said second substrate and forming a gap between said first substrate and said second substrate, wherein voltage is applied to said pixel electrodes to produce electric fields approximately in parallel with a plane defined by said first substrate so that said liquid crystal reacts in an in-plane direction of the plane of said first substrate on the basis of said electric fields,
wherein said spacer beads are surface-treated to have adhesiveness so that said spacer beads adhere at least to said raised portions of said first substrate or to said second substrate.

3. The liquid-crystal display panel according to claim 1, wherein said spacer beads are further surface-treated to have aligmnent control ability.

4. The liquid-crystal display panel according to claim 2, wherein said spacer beads are further surface-treated to have aligmnent control ability.

5. The liquid-crystal display panel according to claim 1, wherein an area where said raised portions are formed corresponds to 7% or more of a display area where an image is displayed in said liquid-crystal display panel.

6. The liquid-crystal display panel according to claim 2, wherein an area where said raised portions are formed corresponds to 7% or more of a display area where an image is displayed in said liquid-crystal display panel.

7. The liquid-crystal display panel according to claim 1, wherein a difference between a diameter of unretained ones of said spacer beads and the gap between said first substrate and said second substrate is 0.1 μm or more.

8. The liquid-crystal display panel according to claim 2, wherein a difference between a diameter of unretained ones of said spacer beads and the gap between said first substrate and said second substrate is 0.1 μm or more.
